(19) United States
(12) Patent Application Publication
(10) Pub. No.: US 2004/0034982 A1
(43) Pub. Date: Feb. 26, 2004

(54) System and method for sealing, baffling or reinforcing

(75) Inventors: Robert Wieber, Lapeer, MI (US); Todd R. Deachin, Goodrich, MI (US)

Correspondence Address: DOBRUSIN & THENNISCH PC, 401 S OLD WOODWARD AVE, SUITE 311, BIRMINGHAM, MI, 48009, US

(73) Assignee: L&L Products, Inc., Romeo, MI

(21) Appl. No.: 10/464,251

(22) Filed: Jun. 18, 2003

Related U.S. Application Data
(60) Provisional application No. 60/399,742, filed on Jul. 30, 2002.

(51) Int. Cl. B23P 11/00

(52) U.S. Cl. 29/428

(57) ABSTRACT

There is disclosed a system and method for sealing, baffling or reinforcing. According to the method, a carrier member is provided having an expandable material disposed thereon. The carrier member is attached to a fastener having a flexible portion and at least one elongated member. The fastener is interference fit through an opening in an article of manufacture (e.g., an automotive vehicle) followed by expanding the expandable material for providing sealing, baffling or reinforcement to the article of manufacture.

### CLAIM OF BENEFIT OF FILING DATE

The present application claims the benefit of the filing date of U.S. Provisional Application Serial No. 60/399,742 (filed Jul. 30, 2002), hereby incorporated by reference.

### FIELD OF THE INVENTION

The present invention relates generally to a system and method for sealing, baffling or reinforcing articles of manufacture. More particularly, the present invention relates to a system having a carrier, a fastener and an expandable material that are employed to cooperatively seal, baffle or reinforce members or components of an automotive vehicle.

### BACKGROUND OF THE INVENTION

For many years, the transportation industry has been concerned with designing systems for sealing, reinforcing or baffling members or components of automotive vehicles. Such systems typically include at least one of a carrier and an expandable material. Oftentimes, it is also desirable for such systems to include one or more fasteners for assisting in attaching the systems to members or components of vehicles particularly prior to expansion of the expandable material. Thus, the present invention seeks to provide an improved system for sealing, reinforcing or baffling that preferably includes an improved fastener.

### SUMMARY OF THE INVENTION

Accordingly, there is provided a system for sealing, reinforcing or baffling and a method for forming and/or using the system. According to the method, there is provided a member of an article of manufacture such as a panel of an automotive vehicle. The member will typically include an opening (e.g., a through-hole) for receiving a fastener that is attached or connected to a carrier. The fastener includes a flexible portion such as a round diaphragm that preferably has an outer perimeter. The carrier has an expandable material disposed thereon and, in one particularly preferred embodiment, the carrier is annular and is attached about the outer perimeter of the flexible portion such that the expandable material can extend continuously or non-continuously about the carrier. The fastener also includes at least a first member and preferably a second member extending from a first surface of the flexible portion. In operation, a force is preferably applied to move the flexible portion of the fastener such that the member of the fastener extends through the opening and is interference fit with the member of the article of manufacture. Thereafter, the expandable material is typically expanded to assist in performing a sealing, reinforcing or baffling function.

In one highly preferred embodiment, the fastener is attached to a member (e.g., a panel of an automotive vehicle) by positioning the carrier and the fastener such that the first member and second member of the fastener are at least partially directed toward the opening of the member of the automotive vehicle. In that position, at least one of the carrier member or the expandable material preferably abuts the panel and the expandable material is preferably at least partially between the carrier and the panel. During or after such positioning, a second surface of the flexible diaphragm is preferably pushed to reverse a first direction of arc of the diaphragm and to extend the first member and the second member of the fastener through the opening of the member of the automotive vehicle. In turn, the first member and the second member preferably spread away from each other to overlap the member of the automotive vehicle and interference the first member and the second member to the member of the automotive vehicle. Thereafter, the expandable material is preferably expanded to at least seal the opening.

### BRIEF DESCRIPTION OF THE DRAWINGS

The features and inventive aspects of the present invention will become more apparent upon reading the following detailed description, claims, and drawings, of which the following is a brief description:

FIG. 1 is a front perspective view of a member prior to assembly of the member to a panel of an automotive vehicle.

FIG. 2 is a rear perspective view of the member of FIG. 1 prior to assembly of the member to the panel of the automotive vehicle.

FIG. 3 is a side sectional view of a member and a panel of an automotive vehicle prior to assembly of the member to the panel.

FIG. 4 is a side sectional view of the member and panel of FIG. 1 after at least partial assembly of the member to the panel.

### DETAILED DESCRIPTION OF THE PREFERRED EMBODIMENT

The present invention is predicated upon providing an improved system for sealing, baffling or reinforcing one or more members of an article of manufacture. The system has found particular utility for automotive vehicles although it is contemplated that the system may be applied to a variety of articles of manufacture such as airplanes, boats, buildings, furniture or the like.

Accordingly, the system of the present invention typically includes one or more of the following:

1) a component or member of an article of manufacture that preferably has an opening;

2) a fastener suitable for insertion within the opening;

3) a carrier attached to the fastener; and

4) an expandable material disposed upon the carrier.

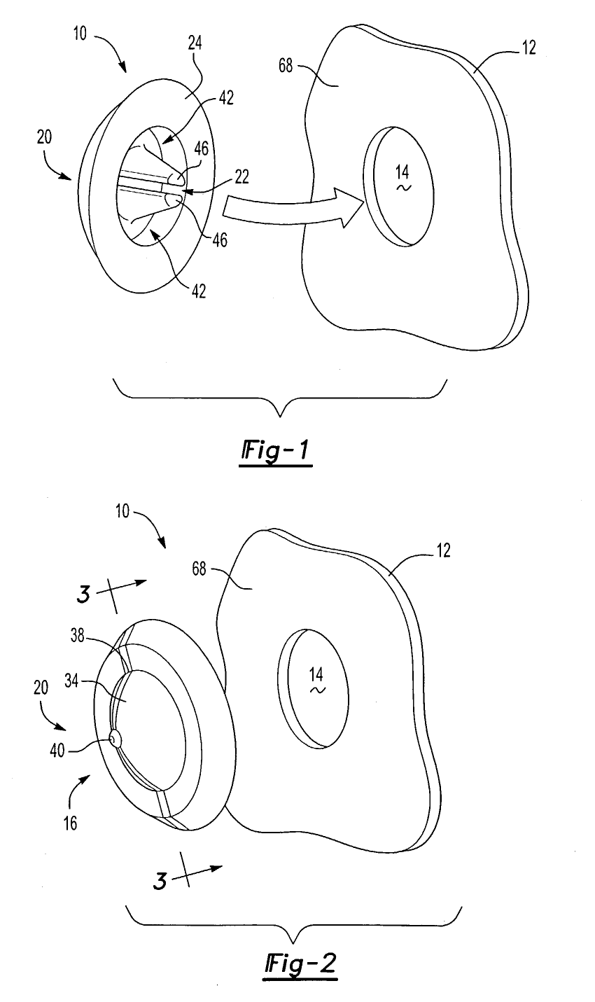

Referring to FIGS. 1-4, there is illustrated one exemplary preferred embodiment of a system 10 formed in accordance with the present invention. The system 10 is provided for purposes of illustration of the present invention. It is contemplated that alternatives to the components and aspects of the system 10 of FIGS. 1-4 may be employed in the practice of the present invention. Some of those alternatives are disclosed below, however, the skilled artisan will appreciate that many other alternatives may also be employed in the practice of the present invention.

The system 10 includes a member or component, which is shown for illustrative purposes as a panel 12, of an automotive vehicle. As shown, the panel 12 includes an opening 14, which is shown as a through-hole. The system 10 also includes a member 16 for sealing the opening 14 of the panel 12.

The member 16 preferably includes a carrier 20, a fastener 22 attached to the carrier 20 and an expandable material 24 disposed on the carrier 20. The fastener 22 includes a flexible portion 30 (e.g., a diaphragm) having a first surface 32 opposing a second surface 34. In the embodiment shown, the flexible portion 30 is circular and includes a circumferential perimeter 38. The flexible portion 30 is also substantially contoured (e.g., arcuate or arcuate dome-shaped) and includes a centrally located dimple 40. Of course, various alternative shapes for the flexible portion 30 may be employed as long as the portion 30 maintains its functionality as further described below.

Two elongated members 42 are attached to and extend from the first surface 32 of the flexible portion 30 to a free end 46 of the members 42. The elongated members 42 are preferably at least partially spaced apart from each other upon the first surface 32 of the flexible portion 30, particularly at the location (e.g., at the base of the members 42) where the members 42 are attached to the flexible portion 30. Preferably, the dimple 40 is located between the members 42.

The carrier 20 is attached to at least part of the perimeter 38 of the flexible portion 30 of the fastener 22. In the preferred embodiment, the carrier 20 includes an annular disc-shaped base portion 50 and an annular outer portion 52 that is disposed at an angle 54 relative to the base portion 50 for forming an annular cavity 56. Also in the preferred embodiment illustrated, the annular outer portion 52 includes an outer perimeter end 58.

The expandable material 24 is preferably disposed continuously or non-continuously within the annular cavity 56 of the carrier 20. In the embodiment shown, the expandable material 24 substantially surrounds the elongated members 42 of the fastener 22.

In the preferred embodiment illustrated, both the fastener 22 and the carrier 20 are formed of polymeric materials (e.g., plastics, elastomers, thermoplastics or the like). It is contemplated, however, that the fastener 22 and the carrier 20 may be formed of a variety of materials such as metals, wood, glass, building materials, any other suitable materials combinations thereof or the like. In the preferred embodiment the fastener 22 and the carrier 20 are integrally formed (e.g., molded) of a substantially plastic material. In a highly preferred embodiment, the fastener 22 and the carrier 20 are injection molded as a singular piece from nylon, which may or may not be glass-filled.

The panel 12 of the vehicle may also be formed of any suitable material that is used on a vehicle. Preferably the panel 12 is formed of a metal (e.g., steel, aluminum, iron, combinations thereof or the like) or a polymeric material although not required.

Preferably, the expandable material 24 is a heat activated material having foamable characteristics. The material may be generally dry to the touch or tacky and can be placed upon carrier 20 in any form of desired pattern, placement, or thickness, but is preferably a substantially uniform thickness. One exemplary expandable material 34 is L-5204 structural foam available through L&L Products, Inc. of Romeo, Mich.

Though other heat activated materials are possible for the expandable material 24, a preferred heat activated material is an expandable plastic, and preferably one that is foamable. A particularly preferred material is an epoxy-based structural or sealing foam. For example, without limitation, the structural foam may be an epoxy-based material, including an ethylene copolymer or terpolymer that may possess an alpha-olefin. As a copolymer or terpolymer, the polymer is composed of two or three different monomers, i.e., small molecules with high chemical reactivity that are capable of linking up with similar molecules.

A number of epoxy-based structural reinforcing, sealing and/or baffling foams are known in the art and may also be used to produce foam. A typical foam includes a polymeric base material, such as an epoxy resin or ethylene-based polymer which, when compounded with appropriate ingredients (typically a blowing and curing agent), expands and cures in a reliable and predicable manner upon the application of heat or the occurrence of a particular ambient condition. From a chemical standpoint for a thermally-activated material, the structural foam is usually initially processed as a flowable thermoplastic material before curing. It will cross-link upon curing, which makes the material incapable of further flow.

An example of a preferred foam formulation is an epoxy-based material that is commercially available from L&L Products of Romeo, Mich., under the designations L5206, L5207, L5208, L5209, L5218, L5224, XP321 and XP721. One advantage of the preferred structural foam materials over prior art materials is that the preferred materials can be processed in several ways. The preferred materials can be processed by injection molding, extrusion compression molding or with a mini-applicator. This enables the formation and creation of part designs that exceed the capability of most prior art materials. In one preferred embodiment, the structural foam (in its uncured state) generally is dry or relatively free of tack to the touch and can easily be attached to the carrier 20 through fastening means, which are well known in the art.

Assembly of the member 16 to the panel 12 includes placing the member 16, and particularly, the expandable material 24 and the end 58 of the carrier 20 into abutting contact with a surface 68 of the panel 12. The member 16 should be positioned such that the fastener 22 substantially aligns with the opening 14 of the panel 12. Additionally, in such position, the members 42 should be at least partially directed toward the opening 14 of the panel 12.

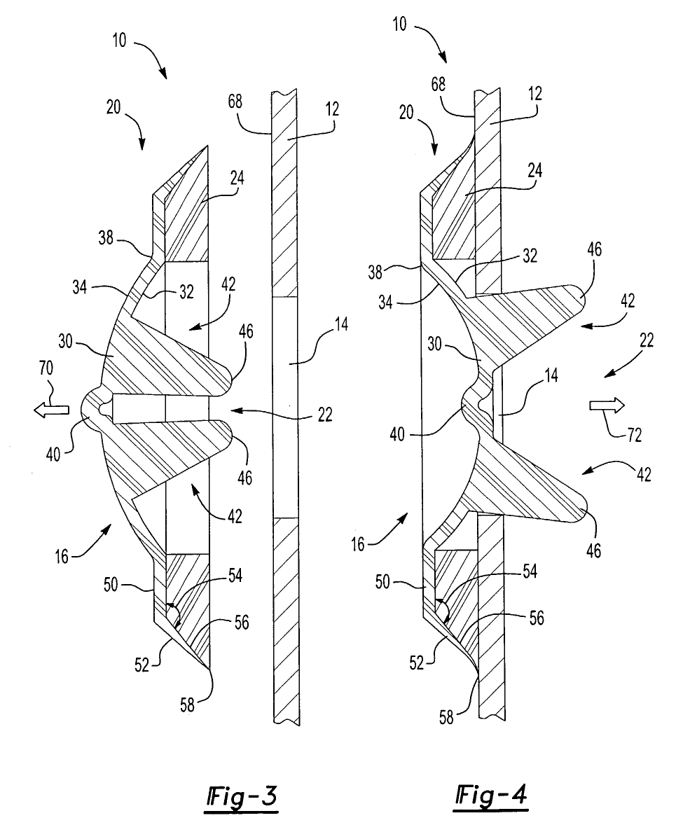

Once the member 16 is positioned as desired, the flexible portion 30 of the fastener 22 is moved such that members 42 extend at least partially through the opening 14 and create an interference fit with the panel 12 to at least temporarily attach the member 16 to the panel 12. In the preferred embodiment illustrated, a force is supplied (e.g., by pushing on the second surface 34 of the flexible portion 30) to the flexible portion 30 that reverses its original direction 70 of arc such that the flexible portion 30 is substantially arcuate in an opposite direction 72 of arc relative to the perimeter 38 of the flexible portion 30 as illustrated going from FIG. 3 to FIG. 4. During such reversal of arc direction, the members 42 extend through the opening 14 and move away from each other to overlap portions of the panel 12 thereby forming the interference fit between the members 42 and the panel 12. For added ease of motion, the flexible portion 30 may include one or more openings (e.g., through-holes), for instance, adjacent the perimeter of the portion 30.

Advantageously, the fastener 22 allows the members 42 to more easily extend through openings such as the opening 14 of the panel 12 of FIGS. 3 and 4, which may have obstructions such as metal burrs or other deformations. Thus, members such as the member 16 illustrated can be more easily fastened to members such as the panel 12. As will be appreciated, the fastener is particular useful for attaching to openings of odd shapes or having burrs or other obstructions that tend to interfere with the insertion of members through the opening.

For the particular embodiment illustrated, the expandable material 24 may be activated after the member 16 is fastened to the panel 12 such that the material 24 expands into the opening 14. In turn, the expandable material 24 in conjunction with the carrier 20, the fastener 22 or both or neither, forms a seal that seals the opening 14 substantially shut. Preferably, the expandable material 24 adheres to the carrier 20 and the panel 12. Advantageously, the outer portion 52 of the carrier 20 controls the expansion of the expandable material 24 and urges the expansion toward the opening 14. Also, the outer portion 52 can act to shed fluid (e.g., water) smoothly away from the opening 14.

As previously discussed, the system 10 of FIGS. 1-4 is an exemplary preferred embodiment of the present invention. It is contemplated that each of the components (i.e., the fastener 22, the carrier 20, the expandable material 24, the panel 12) of the system 10 may be varied without departing from the scope of the present invention. Some variations are discussed below, but the skilled artisan will appreciate that other variations may be made as well without departing from the spirit and scope of the present invention.

With regard to the member of the vehicle, which is shown in FIGS. 1-4 as a panel 12, it is contemplated that a myriad of members or components may be substituted for the panel 12. The member may be a portion of the frame, the body and/or peripheral components of the vehicle. As examples, the member may be part or all of a decklid, a hood, inner or outer body panels, the engine, pillars, trim, seating, dashboard, bumpers, roof, frame, underbody, combinations thereof or the like of the vehicle.

It is contemplated that the carrier 20 of FIGS. 1-4 may be varied significantly. As one exemplary alternative, the carrier may be elongated, skeletal or the like for forming a reinforcement member in conjunction with the expandable material. Such a reinforcement member may be located within a cavity of an automotive vehicle and may be held in place using a fastener such as the fastener 22 of FIGS. 1-4. The fastener would typically extend through an opening of a member of the vehicle (e.g. a member that at least partially forms the cavity) and at least temporarily maintain the reinforcement member in the cavity at least until the expandable material is expanded. As another example, the carrier may be an extension or protrusion for maintaining the expandable material in a cavity of the vehicle such that the expandable material may expand to baffle or seal a cavity. As still another example, it is contemplated that a carrier may extend substantially away from (e.g., perpendicular to) a member (e.g., a panel) for allowing the expandable material to seal locations other than or in addition to an opening to which the fastener is attached. Again, a fastener such as the fastener 22 of FIGS. 1-4 could extend through an opening of a member of the vehicle to at least temporarily maintain the expandable material in the cavity at least until the expandable material is expanded to form the seal, baffle or both. It is also contemplated that the expandable material is attached directly to the fastener with or without a carrier. Moreover, as these examples make clear, it shall be appreciated that the present invention should not be limited to sealing unless such a functional limitation is particularly stated.

With regard to the fastener 22 of FIGS. 1-4 various alternatives may be employed. For example, greater or fewer members may extend from the flexible portion of the fastener. Moreover, the members may or may not be elongated and may have a variety of different shapes and configurations. The flexible portion may also be supplied in a variety of configurations and shapes (e.g., oval, square or the like). As one example, the perimeter of the flexible portion may extend fully or only partially about the flexible portion. As another alternative, greater or fewer dimples may be employed in the flexible portion.

While the preferred materials for fabricating the expandable material 24 have been disclosed, the material 24 can be formed of other materials provided that the material selected is heat-activated or otherwise activated by an ambient condition (e.g. moisture, pressure, time or the like) and cures in a predictable and reliable manner under appropriate conditions for the selected application. One such material is the epoxy based resin disclosed in U.S. Pat. No. 6,131,897, the teachings of which are incorporated herein by reference, filed with the United States Patent and Trademark Office on Mar. 8, 1999 by the assignee of this application. Some other possible materials include, but are not limited to, polyolefin materials, copolymers and terpolymers with at least one monomer type an alpha-olefin, phenol/formaldehyde materials, phenoxy materials, and polyurethane materials with high glass transition temperatures. See also, U.S. Pat. Nos. 5,766,719; 5,755,486; 5,575,526; and 5,932,680, (incorporated by reference). In general, it is desirable for the expandable material to have good corrosion resistance properties.

In applications where the expandable material 24 is a heat activated, thermally expanding material, an important consideration involved with the selection and formulation of the material comprising the foam is the temperature at which a material reaction or expansion, and possibly curing, will take place. For instance, in most applications, it is undesirable for the material to be reactive at room temperature or otherwise at the ambient temperature in a production line environment. More typically, the expandable material becomes reactive at higher processing temperatures, such as those encountered in an automobile assembly plant, when the foam is processed along with the automobile components at elevated temperatures or at higher applied energy levels, e.g., during painting preparation steps. While temperatures encountered in an automobile assembly operation may be in the range of about 148.89° C. to 204.44° C. (about 300° F. to 400° F.), body and paint shop applications are commonly about 93.33° C. (about 200° F.) or slightly higher. If needed, blowing agent activators can be incorporated into the composition to cause expansion at different temperatures outside the above ranges or expansion at different rates or to different degrees.

Generally, suitable expandable foams have a range of expansion ranging from approximately 0 to over 1000 percent. The level of expansion of the expandable material may be increased to as high as 1500 percent or more. Typically, strength is obtained from products that possess low expansion.

Some other possible materials include, but are not limited to, polyolefin materials, copolymers and terpolymers with at least one monomer type an alpha-olefin, phenol/formaldehyde materials, phenoxy materials, and polyurethane. See also, U.S. Pat. Nos. 5,266,133; 5,766,719; 5,755,486; 5,575,526; 5,932,680; and WO 00/27920 (PCT/US 99/24795) (all of which are expressly incorporated by reference). Preferably , the material will withstand the processing conditions typically encountered in the manufacture of a vehicle, such as the e-coat priming, cleaning and degreasing and other coating processes, as well as the painting operations encountered before, during or after vehicle assembly.

In another embodiment, the expandable material 24 is provided in an encapsulated or partially encapsulated form, which may comprise a pellet, which includes an expandable foamable material, encapsulated or partially encapsulated in an adhesive shell. An example of one such system is disclosed in commonly owned, co-pending U.S. application Ser. No. 09/524,298 (“Expandable Pre-Formed Plug”), hereby incorporated by reference.

In addition, as discussed previously, preformed patterns may also be employed such as those made by extruding a sheet (having a flat or contoured surface) and then die cutting it according to a predetermined configuration in accordance with the chosen member or panel, and applying it thereto.

The skilled artisan will appreciate that the system may be employed in combination with or as a component of a conventional sound blocking baffle, or a vehicle structural reinforcement system, such as is disclosed in commonly owned co-pending U.S. application Ser. Nos. 09/524,961 or 09/502,686 (hereby incorporated by reference).

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. A method for sealing, baffling or reinforcing, comprising:
providing a member of an article of manufacture, the member having an opening;
providing a carrier with an expandable material disposed thereon;
providing a fastener connected to the carrier, the fastener including:
i) a flexible portion; and
ii) a member extending from the flexible portion;
applying a force to move the flexible portion of the fastener such that the member of the fastener extends through the opening and is interference fit with the member of the article of manufacture; and
expanding the expandable material to bond with the carrier and the member of the article of manufacture.

2. A method as in claim 1 wherein the fastener and the carrier are integrally formed of a polymeric material.

3. A method as in claim 2 wherein the polymeric material is nylon.

4. A method as in claim 1 wherein the expandable material is epoxy-based.

5. A method as in claim 1 wherein the member of the article of manufacture is selected from a decklid, a hood, a body panel, a pillar, trim, a bumper, a roof, a frame or an underbody of an automotive vehicle.

6. A method as in claim 1 wherein the expandable material is heat activated and the step of expanding the material take place during an e-coat or painting operation of the article of manufacture.

7. A method as in claim 1 wherein the expandable material is at least partially between the carrier member and the member of the article of manufacture during the step of applying the force.

8. A method as in claim 1 wherein the flexible portion is arcuate in a first direction prior to the step of applying the force and arcuate in a second direction after the step of applying the force.

9. A method for sealing an opening, comprising:
providing a member of an automotive vehicle, the member having an opening;
providing an annular carrier with an expandable material disposed thereon;
providing a fastener that is attached to the carrier, the fastener including:
i) a flexible diaphragm that is arcuate in a first direction of arc; and
ii) a first member and a second member extending from a first surface of the flexible diaphragm, the first member spaced apart from the second member;
positioning the carrier and the fastener such that the first member and second member are at least partially directed toward the opening of the member of the automotive vehicle and such that at least one of the carrier member or the expandable material abuts the member of the automotive vehicle and such that the expandable material is between the carrier and the member of the automotive vehicle;
pushing upon a second surface of the flexible diaphragm to reverse the first direction of arc of the diaphragm and to extend the first member and the second member of the fastener through the opening of the member of the automotive vehicle wherein;
i) the first member and the second member spread away from each other to overlap the member of the automotive vehicle and interference the first member and the second member to the member of the automotive vehicle; and
expanding the expandable material to expand into and seal the opening of the member of the automotive vehicle.

10. A method as in claim 9 wherein the fastener and the carrier are integrally formed of a polymeric material.

11. A method as in claim 10, wherein the polymeric material is nylon.

12. A method as in claim 9 wherein the expandable material is epoxy-based.

13. A method as in claim 9 wherein the member of the automotive vehicle is selected from a decklid, a hood, a body panel, a pillar, trim, a bumper, a roof, a frame or an underbody of an automotive vehicle.

14. A method as in claim 9 wherein the expandable material is heat activated and the step of expanding the material take place during e-coat or painting of the automotive vehicle.

15. A method as in claim 9 wherein the expandable material is at least partially between the carrier member and the member of the automotive vehicle during the step of pushing upon a second surface.

16. A method for sealing an opening, comprising:
providing a panel of an automotive vehicle, the panel having a through-hole;
providing a carrier having an annular base portion and an annular outer portion disposed at an angle relative to the annular base portion for forming an annular cavity wherein;
i) a heat expandable material is disposed continuously within the cavity of the carrier;
providing a fastener attached to the carrier, the fastener including:
i) a circular flexible diaphragm that is arcuate in a first direction of arc, the diaphragm having a circumferential outer perimeter attached to the annular base portion of the carrier;
ii) a first member and a second member extending from a first surface of the flexible diaphragm; and
iii) a centrally located dimple upon the flexible diaphragm between the first member and the second member;
positioning the carrier and the fastener such that the first member and second member are at least partially directed toward the opening of the panel of the automotive vehicle;
pushing upon a second surface of the flexible diaphragm to reverse the first direction of arc of the flexible diaphragm into a second direction or arc opposite the first direction of arc thereby extending the first member and the second member of the fastener through the opening of the panel of the automotive vehicle to form an interference fit therebetween; and
expanding the expandable material to seal the opening of the member of the automotive vehicle.

17. A method as in claim 16 wherein the fastener and the carrier are integrally formed of a polymeric material.

18. A method as in claim 17 wherein the polymeric material is nylon.

19. A method as in claim 16 wherein the expandable material is epoxy-based.

20. A method as in claim 16 wherein the expandable material is heat activated and the step of expanding the material take place during e-coat or painting of the automotive vehicle.
